(19) United States
(12) Patent Application Publication
(10) Pub. No.: US 2026/0045245 A1
(43) Pub. Date: Feb. 12, 2026

(54) SOUND INSULATION ASSEMBLY FOR WASTE DISPOSER

(71) Applicant: INSINKERATOR LLC, Benton Harbor, MI (US)

(72) Inventors: LiPing Wang, Franklin, WI (US); Walter A. Bennage, Pleasant Prairie, WI (US); Kelly T. Gamble, Waterford, WI (US)

(21) Appl. No.: 19/284,834

(22) Filed: Jul. 30, 2025

Related U.S. Application Data
(60) Provisional application No. 63/681,472, filed on Aug. 9, 2024.

(51) Int. Cl. G10K 11/16; E03C 1/266

(52) U.S. Cl. CPC G10K 11/161; E03C 1/2665

(57) ABSTRACT

Sound insulation assemblies for use with waste disposers, waste disposer systems having such sound insulation assemblies, and methods of installing such sound insulation assemblies onto waste disposers are provided. The sound insulation assemblies include a sound insulation layer that wraps around an upper portion of the waste disposer housing encompassing at least a grinding section and a food inlet section of the waste disposer, and a sound insulation trim shell layer that attaches to the sound insulation layer and surrounds at least a portion of the sound insulation layer.

### CROSS-REFERENCE TO RELATED APPLICATIONS

This application claims the benefit of U.S. provisional application No. 63/681,472 filed Aug. 9, 2024, the disclosure of which is hereby incorporated in its entirety by reference herein.

### FIELD

The present disclosure relates to waste disposers such as food waste disposers and, more particularly, to sound insulation assemblies for use with such waste disposers.

### BACKGROUND

Food waste disposers are used to comminute food scraps into particles small enough to pass through household drain plumbing. Referring to FIG. 1 (Prior Art), a conventional food waste disposer 10 is often mounted to a sink, such as a kitchen sink (126 in FIG. 2), and includes a food conveying section 12, a motor section 14, and a grinding section 16 disposed between the food conveying section 12 and the motor section 14. The food conveying section 12 includes a housing 18 that forms an inlet for receiving food waste and water. The food conveying section 12 conveys the food waste to the grinding section 16, and the motor section 14 includes a motor imparting rotational movement to a motor shaft to operate the grinding section.

Referring to FIGS. 1 and 2, food waste disposers such as the food waste disposer 10 are generally installed to a sink 126 in a two-step procedure using a mounting assembly 100, an example of which is shown in FIG. 1 (Prior Art) in an exploded manner relative to the food waste disposer 10. First, a sink flange assembly 102, which includes a sink (or strainer) flange 104, a sink gasket 106, a back-up flange 108, an upper mounting flange 110, bolts 112, and a retaining ring 114 are installed or mounted in relation to the sink 202. Second, a disposer assembly 20 including the food waste disposer 10 and also including a mounting (or sealing) gasket 116 and a lower mounting flange 118 are attached to the sink flange assembly 102. The combination of the disposer assembly 20 and the mounting assembly 100 can be considered to constitute an overall food waste disposer assembly 124.

Referring to FIG. 2, the food waste disposer assembly 124 is shown installed or mounted in relation to a sink 126. Although FIG. 2 shows a side elevation view of the food waste disposer assembly 124, FIG. 2 provides a cutaway cross-sectional view of the sink 126, so as to better illustrate how the food waste disposer assembly 124 is installed relative to the sink 126. The food waste disposer assembly 124 particularly includes the disposer assembly 20 that includes the food waste disposer 10 and the mounting assembly (or sink flange assembly) 100 that allows for the disposer assembly 124 to be attached to the sink 126. The food waste disposer may also include a waste inlet 22, which may be an inlet for receiving waste from a dishwasher, and a drain outlet 24, which outputs ground food particles and water from the waste disposer 10 into household drainage plumbing (not shown).

The operation of a food waste disposer 10 includes running the motor (not shown) in the motor section 14, which in turn, causes grinding of the food scraps in the grinding section 16. The motor and the grinding components both generate noise and vibration of the food waste disposer 10. In at least some instances, such noise and vibration may be undesirably loud in conventional food waste disposers.

Accordingly, it would be desirable if an improved waste disposer could be developed that alleviated or addressed one or more of the above-discussed concerns, and/or alleviated or addressed one or more other concerns or disadvantages, and/or provided one or more advantages by comparison with conventional food waste disposers.

### BRIEF SUMMARY

Sound insulation assemblies for use with food waste disposers are provided herein.

In at least a first aspect, a sound insulation assembly is provided that includes a sound insulation layer that wraps around an upper portion of a waste disposer housing encompassing at least a grinding section and a food inlet section of the waste disposer; and a sound insulation trim shell layer that attaches to the sound insulation layer and surrounds at least a portion of the sound insulation layer.

In at least a second aspect, a waste disposer system is provided that includes a disposer assembly and a sound insulation assembly. The disposer assembly includes: a waste disposer having a food inlet section, a motor section, a grinding section disposed between the food inlet section and the motor section, and a waste disposer housing that encompasses the food inlet section, the motor section, and the grinding section; and a mounting assembly connected to the waste disposer and configured to connect the waste disposer to a sink. The sound insulation assembly includes: a sound insulation layer that wraps around an upper portion of the waste disposer housing encompassing at least the grinding section and the food inlet section of the waste disposer; and a sound insulation trim shell layer that attaches to the sound insulation layer and surrounds at least a portion of the sound insulation layer.

In at least a third aspect, a method of installing a sound insultation assembly on a waste disposer is provided that includes: attaching a sound insulation layer to an upper portion of a waste disposer housing encompassing at least a grinding section and a food inlet section of the waste disposer; and attaching a sound insulation trim shell layer to the sound insulation layer, wherein the sound insulation trim shell layer surrounds at least a portion of the sound insulation layer.

### BRIEF DESCRIPTION OF THE DRAWINGS

Specific examples have been chosen for purposes of illustration and description, and are shown in the accompanying drawings, forming a part of the specification.

FIG. 1 is an exploded view of a Prior Art food waste disposer assembly including both a mounting assembly and a disposer assembly including a food waste disposer.

FIG. 2 is a partly cross-sectional, partly front elevation view of the Prior Art food waste disposer assembly of FIG. 1 mounted in relation to a sink.

FIG. 3 is a front perspective view of one example of a sound insulation assembly of the present technology, including a sound insulation layer and a sound insulation trim shell.

FIG. 4 is a cross-sectional side view of the sound insulation assembly of FIG. 3 installed on a food waste disposer.

FIG. 5 is a front perspective view of one example of the sound insulation layer of the sound insulation assembly of FIG. 3.

FIG. 6 is a front perspective view of a left-half of the sound insulation trim shell layer of FIG. 3.

FIG. 7 is a front perspective view of a right-half of the sound insulation trim shell layer of FIG. 3.

FIG. 8 is a left side view of the sound insulation trim shell layer of FIG. 3.

FIG. 9 is a flow diagram of one example of a method of installing a sound insulation assembly of the present technology.

FIG. 10 illustrates a graph of the sound power in dB(A) for sound frequencies, in Hertz (Hz), ranging from 100 Hz to 10000 Hz during testing of one example of a sound insulation assembly of the present technology on a waste disposer.

While various embodiments discussed herein are amenable to modifications and alternative forms, aspects thereof have been shown by way of example in the drawings and are described in detail herein. It should be understood, however, that the disclosure is not limited to the particular embodiments described, including the details of construction, arrangements of components, or other aspects or features illustrated in the drawings, but rather the sound insulation, waste disposers having such sound insulation, and methods encompassed herein include other embodiments or are capable of being practiced or carried out in other various ways. Moreover, the inventions described herein are meant to include all modifications, equivalents, and alternatives falling within the scope of the disclosure. In addition, the terms “example” and “embodiment” as used throughout this application is only by way of illustration, and not limitation, the Figures are not necessarily drawn to scale, and the use of the same reference symbols in different drawings indicates similar or identical items unless otherwise noted. The term “configured to” as used herein with respect to a component being “configured to” have certain structural characteristics in specified circumstances or to perform a function means that the component is structurally formed such that the component meets the structural characteristics in the specified circumstances or performs the function without further modification. The term “about” as used herein with reference to any measurement or physical characteristic means approximately, and includes the stated measurement or physical characteristic plus or minus an amount that is within an acceptable margin of error or other amount of variance that maintains the desired functionality. Directional terms used herein, such as “vertical” or “vertically”, “upper” or “lower”, “top” or “bottom”, and “left” or “right” are relational terms based on the orientation of the components shown in the Figures. Additionally, “vertical” or “vertically” refer to the longitudinal direction of the waste disposer or sound insulation assembly.

### DETAILED DESCRIPTION

Sound insulation assemblies of the present technology for use with food waste disposers generally include a sound insulation layer and a sound insulation trim shell layer.

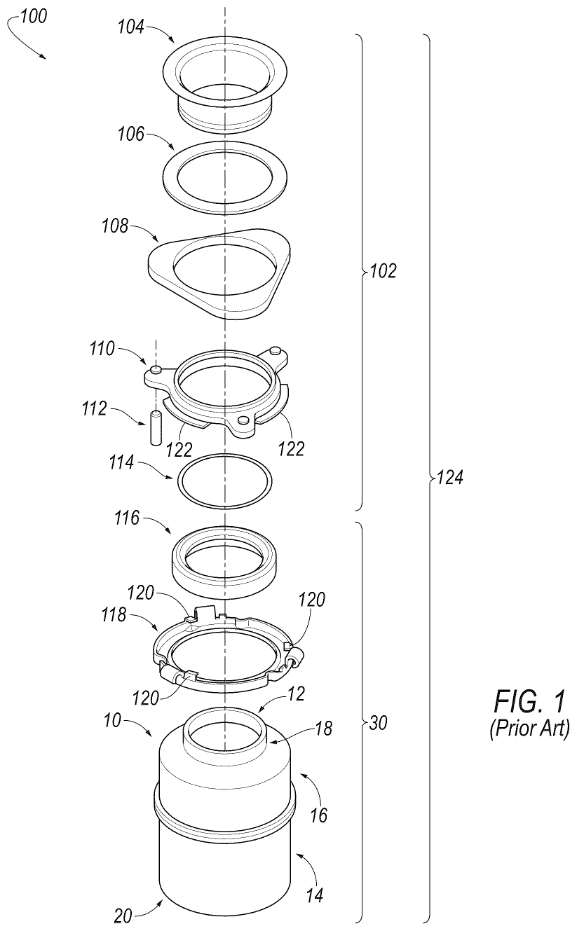

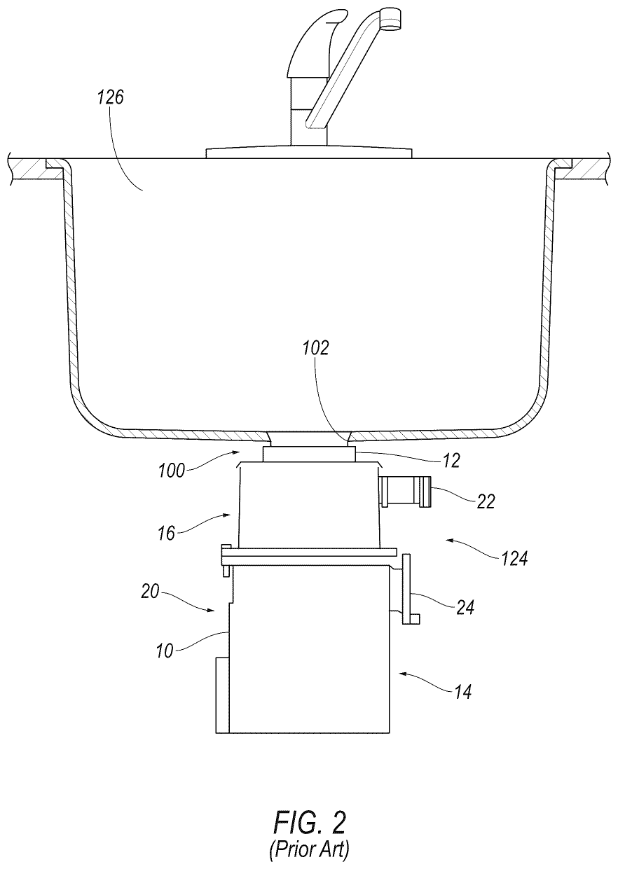

Waste disposer systems of the present technology may include a food waste disposer assembly, such as food waste disposer assembly 124 shown in FIG. 2, which may include a disposer assembly and a mounting assembly, such as disposer assembly 20 and mounting assembly 100 shown in FIGS. 1 and 2, as well as a sound insulation assembly of the present technology.

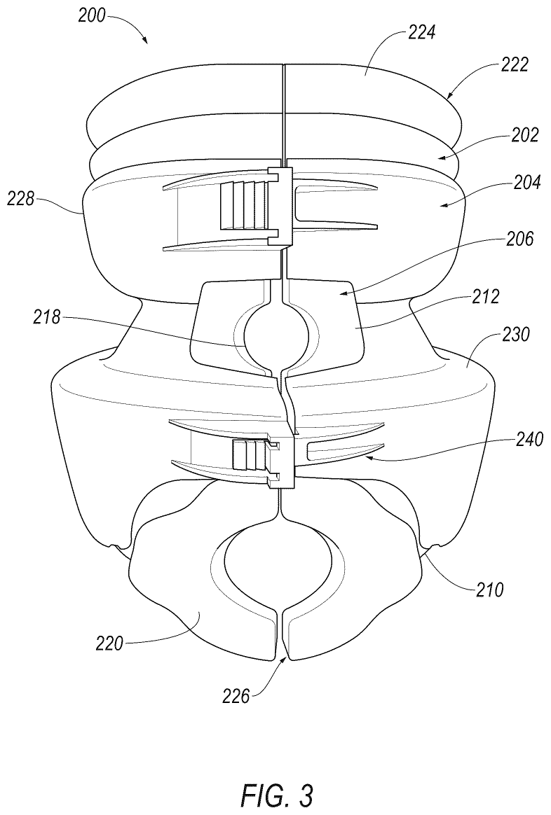

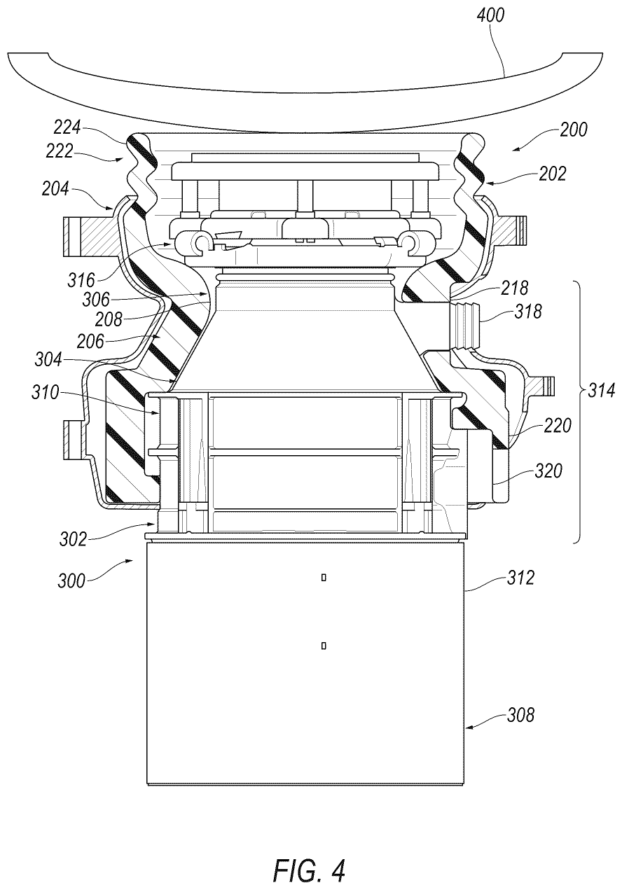

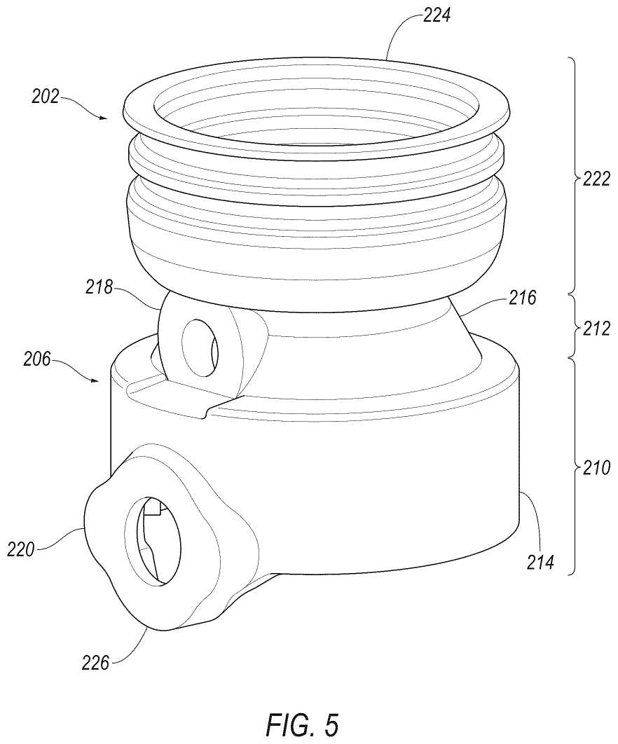

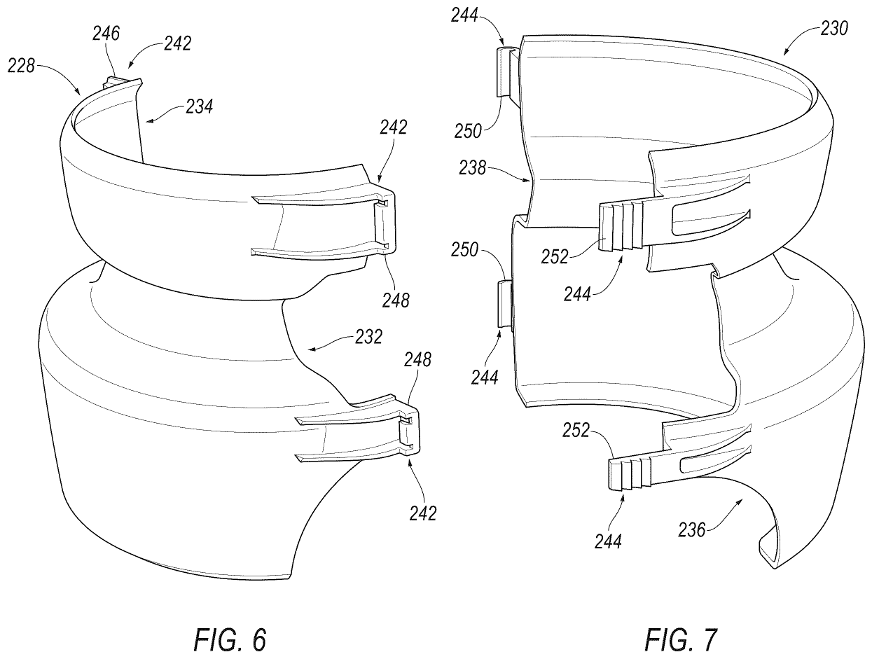

FIG. 3 illustrates one example of a sound insulation assembly 200 of the present technology. FIG. 4 illustrates one example of a waste disposer system 300 of the present technology, which includes the sound insulation assembly 200. Referring to FIGS. 3 and 4, the sound insulation assembly 200 includes a sound insulation layer 202 and a sound insulation trim shell layer 104. In FIG. 5, the sound insulation layer 102 of the sound insulation assembly 200 is shown in isolation, without the sound insulation trim shell layer 104. In FIGS. 6 and 7, the sound insulation trim shell layer 104 is shown.

Referring to FIG. 4, the waste disposer system 300 includes a disposer assembly 302 that includes a waste disposer 304 and a mounting assembly 316. The waste disposer 304 may be similar or identical to waste disposer 10 shown in FIGS. 1 and 2. Likewise, the mounting assembly may be similar or identical to mounting assembly 100 shown in FIGS. 1 and 2.

As shown in FIG. 4, the waste disposer 304 includes a food inlet section 306, a motor section 308, and a grinding section 310 disposed between the food inlet section 306 and the motor section 308. The waste disposer 304 has a waste disposer housing 312 that encompasses the food inlet section 306, the motor section 308, and the grinding section 310. The waste disposer housing 312 includes an upper portion 314 that encompasses at least the grinding section 310 and the food inlet section 306 of the waste disposer 304. A mounting assembly 316 is connected to the waste disposer 304, specifically to the top of the waste disposer at the food inlet section 306. The mounting assembly 316 is configured to and does connect the waste disposer 304 to a sink 400, which may be a kitchen sink.

Referring to FIGS. 3 and 4, the sound insulation assembly 200 includes a sound insulation layer 202 and a sound insulation trim shell layer 204. As shown in FIG. 4, the sound insulation layer 202 wraps around the upper portion 314 of the waste disposer housing 312, encompassing and enclosing at least the grinding section 310 and the food inlet section 306 of the waste disposer 304. The sound insulation trim shell layer 204 is configured to and does attach to the sound insulation layer 202, and surrounds at least a portion of the sound insulation layer 202.

Referring to FIGS. 3, 4 and 5, the sound insulation layer 202 includes a main body 206, which is the portion of the sound insulation layer 202 that wraps around the upper portion 314 of the waste disposer housing 312 (FIG. 4). Referring to FIG. 4, the main body 206 includes an inner wall 208 configured and structured to align with and receive the contours of the upper portion 314 of the waste disposer housing 312.

Referring back to FIGS. 5, as shown in the illustrated example, the main body 206 may include a first section 210 and a second section 212 above the first section 210. The first section 210 may have a first section outer wall 214 that is cylindrical or substantially cylindrical. The second section 212 may have a second section outer wall 216 that is frustoconical or substantially frustoconical.

The main body 206 of the sound insulation layer 202 may also include ports that are configured to and do accommodate the various inlets to and outlets from the waste disposer 304. For example, as shown in FIG. 4, the waste disposer 304 may include a waste inlet 318 and a drain outlet 320. The waste inlet 318 may receive waste and water from a household line, such as a line from a dishwasher. The drain outlet may discharge ground waste particles and water into household drainage plumbing. Correspondingly, as shown in FIGS. 3 and 5, the main body 206 of the sound insulation layer 202 may include a waste inlet port 218 and a drain outlet port 220.

Referring to FIGS. 3, 4, and 5, the main body 206 of the sound insulation layer 202 includes an upper body portion 222 that extends vertically upwards from the main body 206 and has an upper rim 224. Referring to FIG. 4, the upper body portion 222 of the sound insulation layer 202 extends around, and may be configured to extend around, the mounting assembly 316, and may form and be configured to form a seal against the sink 400. The upper body portion 222 of the sound insulation layer 202 may be adjustable or flexible in the vertical direction, and may have an accordion-style configuration as shown in the illustrated example. Accordingly, the upper body portion 222 of the sound insulation layer 202 may adjust or flex in the vertical direction to facilitate formation of a seal between the outer rim 224 and the sink 400.

The sound insulation layer 202 may be formed in any suitable manner, and may be formed in a single piece or multiple pieces. Referring to FIGS. 3 and 5, the sound insulation layer 202 may be formed as a single piece that includes a split seam 226 along the entirety of the length of the sound insulation layer 202 so that the sound insulation layer 202 can be opened and placed around the upper portion 314 of the waste disposer 304.

The sound insulation layer 202 may be made of any suitable material, such as polyurethane foam. In at least one example, the sound insulation layer 202 may be made of a polyurethane foam having a thickness from about 15 mm to about 25 mm, such as about 19 mm, and a density from about 0.10 g/cm3 to about 0.18 g/cm³, such as about 0.13 g/cm3.

The sound insulation trim shell layer 204 is shown as a single unit in FIGS. 3, 4 and 8, and may be provided as two halves that join to form the single unit as shown in FIGS. 6 and 7. Referring to FIG. 3, the sound insulation trim shell layer 204 includes a left-half 228 and a right-half 230 that matingly engages the left half 228. The left-half 228 and the right-half 230 may attach and be attached by one or more mating assemblies 240. A mating assembly 240 for use on a trim shell layer 204 may be any suitable type of mating assembly. Typically, a mating assembly 240 includes a first mating half and a second mating half that matingly attaches to the first mating half. Non-limiting examples of mating assemblies that may be used include: hinges, locking latches, hook and loop, tab and slot, snaps, etc. Each mating assembly 240 may be the same type or a different type than any other mating assembly 240.

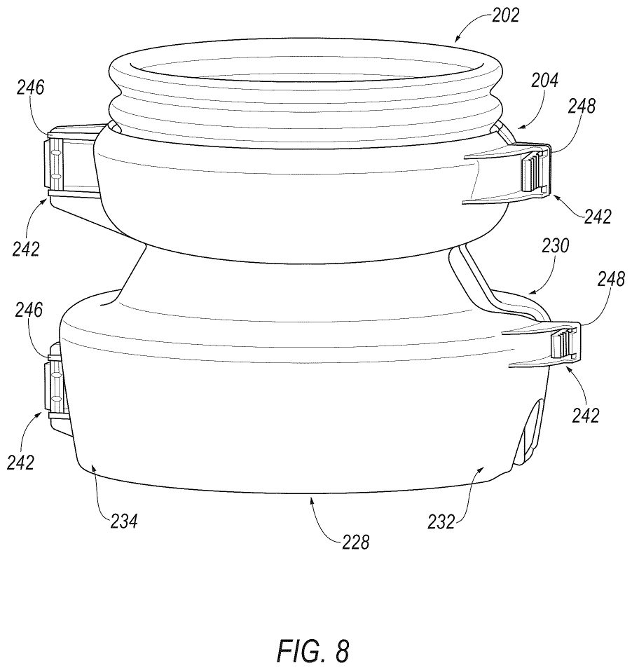

The left-half 228 of the sound insulation trim shell layer 204 is shown in isolation in FIG. 6, the right-half 230 of the sound insulation trim shell layer 204 is shown in isolation in FIG. 7, and FIG. 8 is a side view of the left-half 228 and the right-half 230 joined together. Referring to FIGS. 6 and 8, the left-half 228 of the sound insulation trim shell layer 204 may include a left front side 232 and a left rear side 234. The left front side 232 and the left rear side 234 of the left-half 228 may each include at least one first half 242 of a mating assembly 240. Referring to FIG. 7, the right-half 230 of the sound insulation trim shell layer 204 may include a right front side 236 and a right rear side 238. The right front side 236 and the right rear side 238 of the right-half 230 may each include at least one second half 244 of a mating assembly 240 that is configured to and does matingly attach to the corresponding first half 242 of the mating assembly 240 on the left-half 228. In the example illustrated in FIGS. 6, 7 and 8, there is at least one hinge mating assembly, and as shown there are two, on the rear of the sound insulation trim shell layer and at least one tab and slot mating assembly, and as shown there are two, on the front of the sound insulation trim shell layer. Accordingly, the left-half 228 of the sound insulation trim shell layer 204 includes at least one rear locking hinge 246, and as shown there are two, on the left rear side 234, and at least one front locking slot 248, and as shown there are two, on the left front side 232 opposite the left rear side 234. The right-half 230 of the sound insulation trim shell layer 204 includes at least one right rear locking hook 250, and as shown there are two, on the right rear side 238 that matingly engages the corresponding left rear hinge 246, and at least one front locking tab 252, and as shown there are two, on the right front side 236 opposite the right rear side 238 that matingly engages the corresponding front locking slot 248.

The sound insulation trim shell layer 204 may be made of any suitable material, such as plastic, metal, impact copolymer pp 7035E4, medium copolymers, or combinations thereof. The sound insulation shell layer 204 material may have any suitable properties, such as a high melt flow rate and/or being suitable for injection molding. In at least one example, the sound insulation shell layer 204 material may have a melt flow rate of about 35 g/10 min, a density of about 0.9 g/cm3, a tensile strength at yield of about 23 MPa, an elongation of about 8%, and a heat deflection temperature of about 84° C.

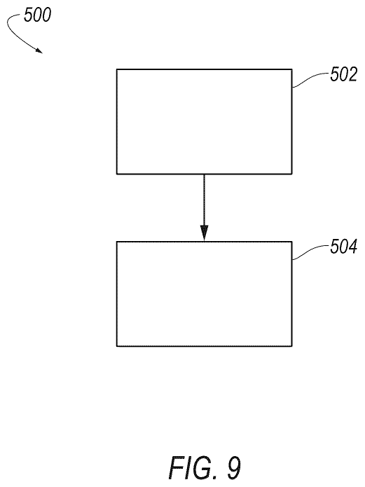

FIG. 9 illustrates one example of a method 500 of installing a sound insultation assembly on a waste disposer. The waste disposer may be a waste disposer 304, and may have any or all of the features described above with respect to waste disposer 304. The sound insulation assembly may be a sound insulation assembly 200, and may have any or all of the features described above with respect to sound insulation assembly 200.

The method 500 may start at step 502, which includes attaching a sound insulation layer to an upper portion of a waste disposer housing encompassing at least a grinding section and a food inlet section of the waste disposer. Referring to FIG. 4, in an example using the waste disposer 304 and sound insulation assembly 200, step 502 includes attaching the sound insulation layer 202 to an upper portion 314 of the waste disposer housing 312 that encompasses at least the grinding section 310 and the food inlet section 306 of the waste disposer 304.

The method may proceed to step 504, which includes attaching a sound insulation trim shell layer to the sound insulation layer, wherein the sound insulation trim shell layer surrounds at least a portion of the sound insulation layer. Referring to FIG. 4, in an example using the waste disposer 304 and sound insulation assembly 200, step 504 includes attaching the sound insulation trim shell layer 204 to the sound insulation layer 202, wherein the sound insulation trim shell layer 204 surrounds at least a portion of the sound insulation layer 202.

In some examples, the sound insulation trim shell layer may be provided in two halves. Referring to FIGS. 6 and 7, in an example using the sound insulation assembly 200, the left-half 228 of the sound insulation trim shell layer 204 includes a rear locking hinge 246 on the left rear side 234 and a front locking slot 248 on the left front side 232 opposite the left rear side 234. In this example, a right-half 238 of the sound insulation trim shell layer 204 includes a right rear locking hook 250 on the right rear side 238 that matingly engages the left rear hinge 246, and a right front locking tab 252 on the right front side 236 opposite the right rear side 238 that matingly engages the front locking slot 248. In such an example, step 504 of attaching a sound insulation trim shell layer to the sound insulation layer may include engaging the rear locking hook 250 onto the rear looking hinge 246, and engaging the front locking tab 252 with the front locking slot 248.

### Noise Reduction Testing

Sound power testing was conducted on an example of a waste disposer having the features discussed above with respect to waste disposer 304, both with and without a sound insulation assembly having a sound insulation layer and sound insulation trim shell layer in accordance with the sound insulation assembly 200 shown in FIGS. 3-7 and discussed above. Each of the two tests was conducted in accordance with the IEC 60704-2-15 acoustic test standard for food waste disposers. In each test, fifteen Nylon 66 balls were placed inside the grind chamber, each spherical nylon ball having a diameter of 12.7 mm (0.5 inch). The flow rate of the inflow water through the disposer baffle on the top was 5.7 liters per minute (1.5 gallons per minute). The waste disposer grinding operation was commenced, and the sound power output was measured in A-weighted decibels (dB(A)) as a 10-second average of the nylon ball grinding noise. The upper limit of the mean for the 95% confidence interval for the two tests was compared, with the result being 93.4 dB(A) for the waste disposer having the sound insulation assembly installed thereon, and 99.9 dB(A) for the waste disposer without the sound insulation assembly. Accordingly, the sound insulation assembly provided a 6.5 dB(A) reduction in the measured sound power.

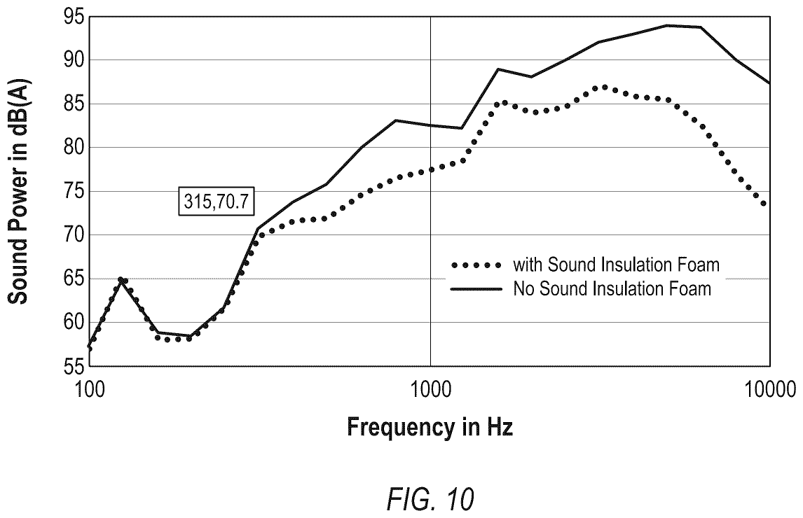

Table 1 below lists the data points and FIG. 10 illustrates a graph of the sound power in dB(A) for sound frequencies, in Hertz (Hz), ranging from 100 Hz to 10000 Hz during the testing. As shown in the graph of FIG. 10, there is a significant sound reduction in high frequencies, such as frequencies above about 315 Hz.

TABLE 1

| | With Sound | No Sound |
|---|---|---|
| | Insulation | Insulation |
| Frequency [Hz] | Foam | Foam |
| 100 | 57.0 | 57.2 |
| 125 | 65.4 | 64.7 |
| 160 | 58.0 | 58.8 |
| 200 | 58.1 | 58.4 |
| 250 | 61.7 | 61.7 |
| 315 | 69.8 | 70.7 |
| 400 | 71.6 | 73.8 |
| 500 | 71.9 | 75.8 |
| 630 | 74.6 | 79.9 |
| 800 | 76.5 | 83.1 |
| 1000 | 77.4 | 82.5 |
| 1250 | 78.5 | 82.2 |
| 1600 | 85.4 | 88.9 |
| 2000 | 84.0 | 88.1 |
| 2500 | 84.6 | 89.9 |
| 3150 | 87.1 | 92.0 |
| 4000 | 85.8 | 93.0 |
| 5000 | 85.5 | 93.9 |
| 6300 | 82.5 | 93.7 |
| 8000 | 76.8 | 90.0 |
| 10000 | 72.8 | 87.4 |
| Overall Level | 94.2 | 101.2 |
| 100-10000 Hz | | |

It should be understood that embodiments of sound insulation assemblies, waste disposer systems, and methods of installing sound insulation assemblies on waste disposers in accordance with the present technology may include various combinations of the features discussed with respect to the illustrated examples above.

In at least a first embodiment, a sound insulation assembly may include a sound insulation layer that wraps around an upper portion of a waste disposer housing encompassing at least a grinding section and a food inlet section of the waste disposer; and a sound insulation trim shell layer that attaches to the sound insulation layer and surrounds at least a portion of the sound insulation layer.

In at least a second embodiment, a waste disposer system may include a disposer assembly and a sound insulation assembly. The disposer assembly may include: a waste disposer having a food inlet section, a motor section, a grinding section disposed between the food inlet section and the motor section, and a waste disposer housing that encompasses the food inlet section, the motor section, and the grinding section; and a mounting assembly connected to the waste disposer and configured to connect the waste disposer to a sink. The sound insulation assembly may include: a sound insulation layer that wraps around an upper portion of a the waste disposer housing encompassing at least the grinding section and the food inlet section of the waste disposer; and a sound insulation trim shell layer that attaches to the sound insulation layer and surrounds at least a portion of the sound insulation layer.

Examples of sound insulation assemblies and waste disposer systems of the first and second embodiments discussed above may further include one or more additional features. For example, the sound insulation layer may comprise a main body that wraps around the upper portion of a waste disposer housing. The main body may comprise an inner wall structured to align with and receive the contours of the upper portion of the waste disposer housing. The main body may include a first section having a first section outer wall that is substantially cylindrical. The main body may include a second section above the first section, the second section having a second section outer wall that is substantially frustoconical. The main body may comprise a waste inlet port and a drain outlet port. In addition to the main body, the sound insulation layer may further comprise an upper body portion that extends vertically upwards from the main body. Further, the sound insulation trim shell layer may comprise a left-half and a right-half that matingly engages the left half. In some such examples, the left front side and the left rear side of the left-half may each include at least one first half of a mating assembly, and the right front side and the right rear side of the right-half may each include at least one second half of the mating assembly that matingly attaches to the corresponding first half of the mating assembly on the left-half. In at least one such example, the left-half of the sound insulation trim shell layer may include a rear locking hinge on a left rear side and a front locking slot on a left front side opposite the left rear side, and the right-half of the sound insulation trim shell layer may include a right rear locking hook on a right rear side that matingly engages the left rear hinge, and a front locking tab on a right front side opposite the right rear side that matingly engages the front locking slot.

In yet another example, a method of installing a sound insultation assembly on a waste disposer may include: attaching a sound insulation layer to an upper portion of a waste disposer housing encompassing at least a grinding section and a food inlet section of the waste disposer; and attaching a sound insulation trim shell layer to the sound insulation layer, wherein the sound insulation trim shell layer surrounds at least a portion of the sound insulation layer. In at least some examples, a left-half of the sound insulation trim shell layer may include a rear locking hinge on a left rear side and a front locking slot on a left front side opposite the left rear side, and a right-half of the sound insulation trim shell layer may include a right rear locking hook on a right rear side that matingly engages the left rear hinge and a right front locking tab on a right front side opposite the right rear side that matingly engages the front locking slot. In such examples, attaching a sound insulation trim shell layer to the sound insulation layer may comprise: engaging the rear locking hook onto the rear looking hinge, and engaging the front locking tab with the front locking slot.

Notwithstanding the above description, the present disclosure is intended to encompass additional embodiments and modified versions of the above-described embodiments in addition to the embodiments specifically described above. Among other things, although the above description refers specifically to food waste disposers, the present disclosure is also intended to encompass embodiments relating to other types of waste disposers.

It is specifically intended that the present invention not be limited to the embodiments and illustrations contained herein, but include modified forms of those embodiments including portions of the embodiments and combinations of elements of different embodiments as come within the scope of the following claims.

We claim:

1. A sound insulation assembly for use with a waste disposer having a waste disposer housing, the sound insulation assembly comprising:
a sound insulation layer that wraps around an upper portion of a waste disposer housing encompassing at least a grinding section and a food inlet section of the waste disposer; and
a sound insulation trim shell layer that attaches to the sound insulation layer and surrounds at least a portion of the sound insulation layer.

2. The sound insulation assembly of claim 1, wherein the sound insulation layer comprises a main body that wraps around the upper portion of a waste disposer housing.

3. The sound insulation assembly of claim 2, wherein the main body comprises an inner wall structured to align with and receive contours of the upper portion of the waste disposer housing.

4. The sound insulation assembly of claim 2, wherein the main body includes a first section having a first section outer wall that is substantially cylindrical.

5. The sound insulation assembly of claim 2, wherein the main body includes a second section above the first section, the second section having a second section outer wall that is substantially frustoconical.

6. The sound insulation assembly of claim 2, wherein the main body comprises a waste inlet port and a drain outlet port.

7. The sound insulation assembly of claim 2, wherein the sound insulation layer further comprises an upper body portion that extends vertically upwards from the main body.

8. The sound insulation assembly of claim 1, wherein the sound insulation trim shell layer comprises a left-half and a right-half that matingly engages the left half.

9. The sound insulation assembly of claim 1, wherein:
the left-half of the sound insulation trim shell layer includes a rear locking hinge on a left rear side and a front locking slot on a left front side opposite the left rear side;
the right-half of the sound insulation trim shell layer includes a right rear locking hook on a right rear side that matingly engages the left rear hinge, and a front locking tab on a right front side opposite the right rear side that matingly engages the front locking slot.

10. A waste disposer system comprising:
a disposer assembly that includes:
a waste disposer having a food inlet section, a motor section, a grinding section disposed between the food inlet section and the motor section, and a waste disposer housing that encompasses the food inlet section, the motor section, and the grinding section;
a mounting assembly connected to the waste disposer and configured to connect the waste disposer to a sink; and
a sound insulation assembly that includes:
a sound insulation layer that wraps around an upper portion of a the waste disposer housing encompassing at least the grinding section and the food inlet section of the waste disposer; and
a sound insulation trim shell layer that attaches to the sound insulation layer and surrounds at least a portion of the sound insulation layer.

11. The waste disposer system of claim 10, wherein the sound insulation layer comprises a main body that wraps around the upper portion of a waste disposer housing.

12. The waste disposer system of claim 11, wherein the main body comprises an inner wall structured to align with and receive contours of the upper portion of the waste disposer housing.

13. The waste disposer system of claim 11, wherein the main body includes a first section having a first section outer wall that is substantially cylindrical.

14. The waste disposer system of claim 11, wherein the main body includes a second section above the first section, the second section having a second section outer wall that is substantially frustoconical.

15. The waste disposer system of claim 11, wherein the main body comprises a waste inlet port and a drain outlet port.

16. The waste disposer system of claim 11, wherein the sound insulation layer further comprises an upper body portion that extends vertically upwards from the main body.

17. The waste disposer system of claim 10, wherein the sound insulation trim shell layer comprises a left-half and a right-half that matingly engages the left half.

18. The waste disposer system of claim 10, wherein:
the left-half of the sound insulation trim shell layer includes a rear locking hinge on a left rear side and a front locking slot on a left front side opposite the left rear side;
the right-half of the sound insulation trim shell layer includes a rear locking hook on a right rear side that matingly engages the rear locking hinge, and a front locking tab on a right front side opposite the right rear side that matingly engages the front locking slot.

19. A method of installing a sound insultation assembly on a waste disposer, the method comprising:
attaching a sound insulation layer to an upper portion of a waste disposer housing encompassing at least a grinding section and a food inlet section of the waste disposer; and
attaching a sound insulation trim shell layer to the sound insulation layer, wherein the sound insulation trim shell layer surrounds at least a portion of the sound insulation layer.

20. The method of claim 19, wherein a left-half of the sound insulation trim shell layer includes a rear locking hinge on a left rear side and a front locking slot on a left front side opposite the left rear side, and a right-half of the sound insulation trim shell layer includes a right rear locking hook on a right rear side that matingly engages the left rear hinge and a right front locking tab on a right front side opposite the right rear side that matingly engages the front locking slot; and attaching a sound insulation trim shell layer to the sound insulation layer comprises:
engaging the rear locking hook onto the rear looking hinge; and
engaging the front locking tab with the front locking slot.
